(19) United States
(12) Patent Application Publication
(10) Pub. No.: US 2008/0276177 A1
(43) Pub. Date: Nov. 6, 2008

(54) Tag-sharing and tag-sharing application program interface

(75) Inventor: Aaron J. Sauve, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/799,829

(22) Filed: May 3, 2007

(51) Int. Cl. G06F 3/00

(52) U.S. Cl. 715/733

(57) ABSTRACT

Various embodiments provide a mechanism by which a user's tags can be shared across a variety of web sites, applications or services, in addition to those web sites where a particular tag may have been created. In one or more embodiments, an application program interface (API) is provided and exposes one or more methods by which a user's tags can be exposed. Once a user's tags are exposed and discoverable, various services and information can be provided which are tailored to a particular individual as a function of their tags.

### BACKGROUND

Many web sites are beginning to adopt “tagging” (or social bookmarking) as a means for users to help categorize items such as photos, videos, blogs, and other items associated with a particular site. Tagging provides a way to assign categories to an item on the web, but it can also be used to help categorize an item on a computing device, such as a favorite, or any other URL that a user may find online.

Although tagging is prevalent, there is no easy way to share tags across a variety of different web sites, services or applications to provide an insight into a person's interests.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a mechanism by which a user's tags can be shared across a variety of web sites, applications or services, in addition to those web sites where a particular tag may have been created. In one or more embodiments, an application program interface (API) is provided and exposes one or more methods by which a user's tags can be exposed. Once a user's tags are exposed and discoverable, various services and information can be provided which are tailored to a particular individual as a function of their tags.

In one or more embodiments, an API is supported by a web browser and provides a means by which other entities, such as web sites, can ascertain tags associated with a particular individual. Once the tags are discovered, these other web sites can offer a host of services that are specifically tailored to the individual as a function of the individual's tags.

### BRIEF DESCRIPTION OF THE DRAWINGS

The same numbers are used throughout the drawings to reference like features.

FIG. 1 illustrates a system in which various principles described herein can be employed in accordance with one or more embodiments.

FIG. 2 illustrates a system in accordance with one or more embodiments.

FIG. 3 illustrates a system in accordance with one or more embodiments.

FIG. 4 illustrates an example user interface in accordance with one or more embodiments.

FIG. 5 is a flow diagram that illustrates a method in accordance with one or more embodiments.

FIG. 6 is a flow diagram that illustrates a method in accordance with one or more embodiments.

FIG. 7 illustrates an example system that can be used to implement one or more embodiments.

### DETAILED DESCRIPTION

Overview

Various embodiments provide a mechanism by which a user's tags can be shared across a variety of web sites, applications or services, in addition to those web sites where a particular tag may have been created. In one or more embodiments, an application program interface (API) is provided and exposes one or more methods by which a user's tags can be exposed. Once a user's tags are exposed and discoverable, various services and information can be provided which are tailored to a particular individual as a function of their tags. Alternately or additionally, tags that have been selected by a user for sharing can be shared with web sites, applications or services automatically without utilizing a special API call. Such might be the case, for example, by including the tags in header information that is transmitted to these various entities.

In one or more embodiments, an API is supported by a web browser and provides a means by which other entities, such as web sites, can ascertain tags associated with a particular individual. Once the tags are discovered, these other web sites can offer a host of services that are specifically tailored to the individual as a function of the individual's tags. Accordingly, the web browser can enable a user's tags to be shared with multiple different web sites.

In the discussion that follows, a section entitled “Operating Environment” is provided and describes one environment in which one or more embodiments can be employed. Following this, a section entitled “Tagging in General” is provided and discusses some general principles associated with tagging. Following this, a section entitled “Example Embodiment” describes one or more embodiments in which tags can be created and shared across multiple entities. A section entitled “Example Method” follows and describes a method in accordance with one or more embodiments. Last, a section entitled “Example System” is provided and describes an example system that can be utilized to implement one or more embodiments.

Overating Environment

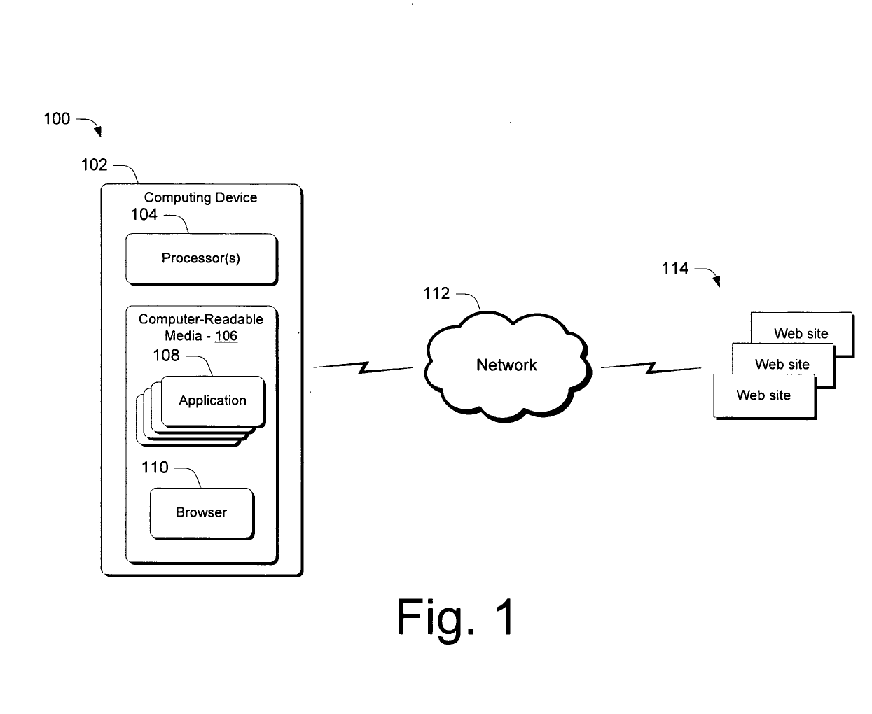

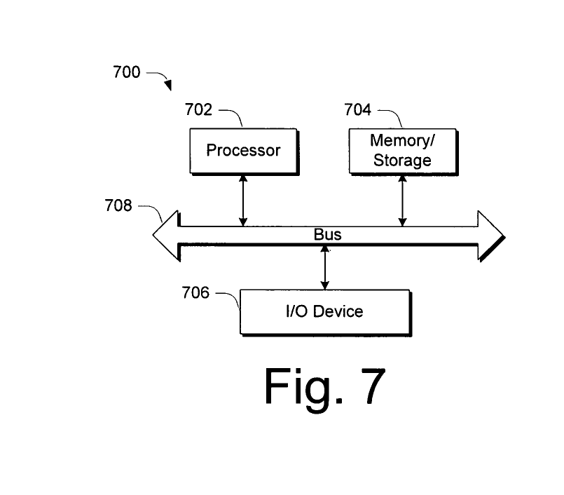

FIG. 1 illustrates an operating environment in accordance with one or more embodiments, generally at 100. Environment 100 includes a computing device 102 having one or more processors 104, one or more computer-readable media 106 and one or more applications 108 that reside on the computer-readable media and which are executable by the processor(s). The computer-readable media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 7.

In addition, computing device 102 includes a software application in the form of a web browser 110. Any suitable web browser can be used examples of which are available from the assignee of this document and others. In at least some embodiments, web browser 110 is configured to enable a user's tags to be shared with other entities, such as web sites, services or applications, as will become apparent below.

In addition, environment 100 includes a network 112, such as the Internet, and one or more web sites 114. The web sites can support various services or applications with which a user's tags can be shared, as will become apparent below.

Computing device 102 can be embodied as any suitable computing device such as, by way of example and not limitation, a desktop computer, a portable computer, a handheld computer such as a personal digital assistants (PDA), cell phone, and the like.

Tagging in General

One of the principal instruments for creating networks of virtual communities (or online social networks, as they are often called) is “tagging.” Tagging refers to a process that allows individuals to apply whatever labels they think best describe content of the web so that they can organize and consume the content. Users can tag not only the content of a particular web site, but also the web site itself. Tagging can be part of an overall social experience of a web site, e.g. by being used to organize photos on a photo-posting site, or it can be the primary focus for cataloging online information on social bookmarking sites (such as del.icio.us, where content with a URL can be tagged, organized, and shared).

The tagging process is a user-driven, user-focused process. Specifically, users develop their own tags that describe their ways of conceiving and describing things and their ways of classifying and organizing their world. In many instances, a user's use of tags will reflect, in some way, their particular interests. Thus, many times, there is a correlation between a user's top tags (i.e. those that are most frequently used) and a user's top interests.

As will be appreciated by the skilled artisan, tags can be created and applied by an individual in any number of ways. For example, when a user visits a particular web site, the web site may have a user interface component that provides a mechanism by which the individual can apply a tag to specific content on that site. Additionally, the user's web browser may enable the user to apply tags to URLs (such as a web site's URL) or links that they visit. For example, in a “Favorites” folder, a user may be given an opportunity to tag a site with a particular tag, such as “bike racing”, “model plane building” and the like. These tags then provide an index by which the user can search for favorites.

In one or more embodiments, a tag can be created through the use of other information that a user provides. This other information can serve as a source of tags. For example, a user may provide a description or comments pertaining to a particular web site or content. From these comments, individual tags can then be pulled from, for example, key words that a user may have used in their description or comments. For example, a user may comment about a particular site as follows: “This site is a really good site for downhill mountain bike racing.” From this, the term “downhill mountain bike racing” might be ascertained to comprise a suitable tag. Alternately or additionally, a user may be able, through a suitably configured user interface, to directly input their interests.

Having described the general nature of tags, consider now embodiments in which a user's created tags can be shared among other entities in accordance with one or more embodiments.

### Example Embodiment

Various embodiments provide a mechanism by which a user's tags can be shared across web sites, applications or services, in addition to those web sites where a particular tag may have been created. In one or more embodiments, an application program interface (API) is provided and exposes one or more methods by which a user's tags can be exposed. Once a user's tags are exposed and discoverable, various services can be provided which are tailored to a particular individual as a function of their tags.

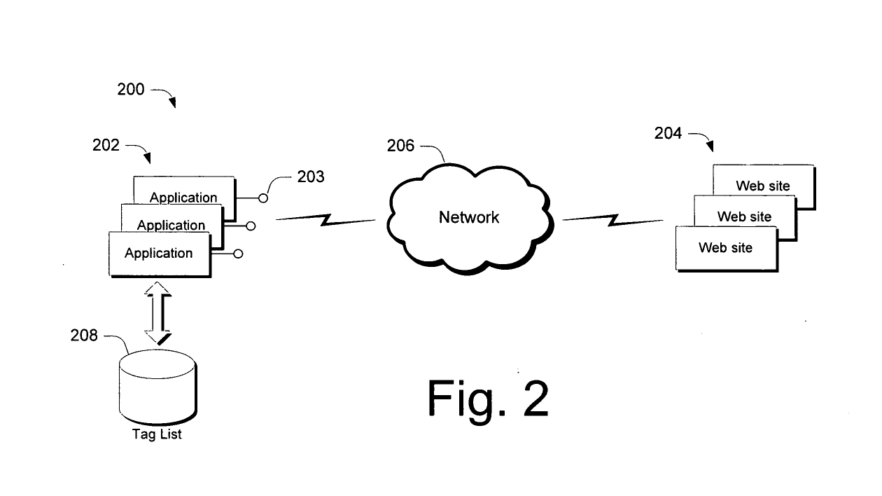

As an example of one system in which a user's tags can be created and shared, consider FIG. 2. There, a system 200 includes one or more applications 202, one or more web sites 204 communicatively linked via a network 206 such as the Internet, and a store 208 that stores a user's tag list. In this example, it is assumed that applications 202 and store 208 reside on or are otherwise accessible by computing device 102 (FIG. 1), which constitutes a user's local computing device.

In operation, a user can create tags in any suitable manner using any suitable application, such as one of applications 202. Applications 202 can include any type of application that enables a user to create a tag. By way of example and not limitation, such applications can include those that are configured to access the Internet, such as instant messaging applications and other web-enabled applications. In addition, some applications, such as word processing applications, file system access applications and the like, can provide the user with the ability to classify and tag documents or content from the Internet using tags they have created.

When a user creates a tag, whether tagging individual content of a web site or the web site itself, the tag is stored in store 208 along with any other suitable metadata that might be created with or subsequent to creating the tag. Such metadata can include, by way of example and not limitation, an indication of whether a user has chosen to share a tag, the frequency of use of a particular tag, most recently used tags, a description of the tag and/or which services or web sites the user has chosen to share with, and the like. Over time, store 208 can come to include a large number of tags that the user has created along with other relevant metadata.

As illustrated, applications 202 include an application program interface 203 (denoted by the plug notation) that can be used to expose the user's tags. Specifically, the application program interface or API can expose a callable method, such as GetTags( ), which can be called by other entities to ascertain which tags a user has chosen to expose. Hence, by calling the appropriate API, an entity such as one or more of web sites 204 can learn which tags a particular user has chosen to share. By knowing which tags a user has chosen to share, a number of services can be provided for the user. Alternately or additionally, the API can be configured, through its arguments, to allow a caller to ask for tags sorted in any particular manner, e.g. by the number of occurrences (i.e. most frequently used), by a ranked list of favorite tags, by a user-specified number of tags, by a specified number of tags (i.e. no more than 5), and the like.

For example, some web sites might use the user's tags to specifically construct a front page with content that is tailored to the user's interests as a function of their tags. For example, a news site might construct a front page that includes new articles that have content that is associated with one or more of a user's tags. Alternately or additionally, other web sites, such as auction sites and commercial purchasing sites, might present content for bidding or purchase that is tailored to a particular user as a function of their tags. Alternately or additionally, a site may select advertisements that are tailored to a particular user based upon their tags. Accordingly, any number of services and/or information may be offered to a user based upon the tags that they have chosen to share.

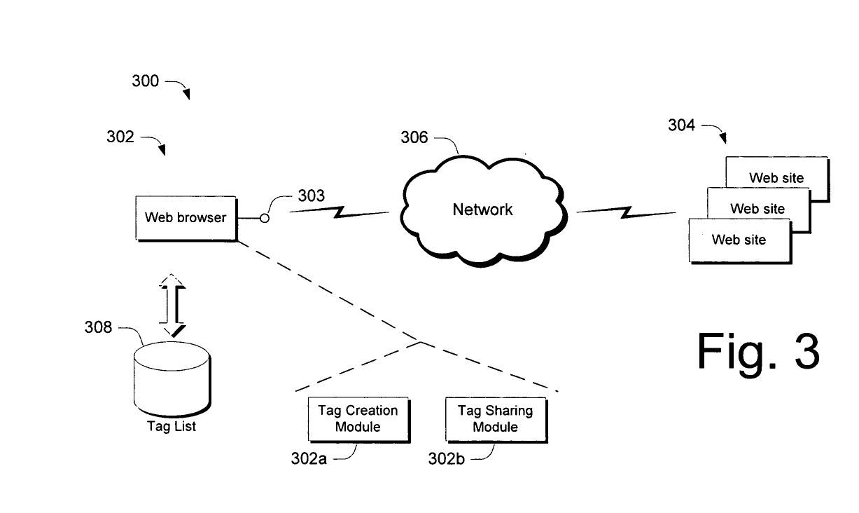

As a specific example of a system that can include tag-creating and tag-sharing functionality, consider FIG. 3. There, a system 300 includes a web browser 302 having an API 303 (such as the one described above), one or more web sites 304 communicatively linked via a network 306 such as the Internet, and a store 308 that stores a user's tag jist. In this example, the web browser includes a tag creation module 302a that enables a user to create a tag, and a tag-sharing module 302b that allows the user to share created tags with other entities. In at least some embodiments, API 303 comprises part of the tag-sharing module. In this example, it is assumed that web browser 302 and store 308 reside on or are otherwise accessible by computing device 102 (FIG. 1), which constitutes a user's local computing device.

In operation, a user can create tags using web browser 302 via, for example, tag creation module 302a. Such tags can be created to tag individual content of a web site or the web site itself. When a user creates a tag, the tag is stored in store 308 along with any other suitable metadata that might be created with or subsequent to creating the tag. Examples of such metadata are provided above. The user can create tags in other ways as well. For example, in some embodiments, web sites can use <meta> tags to provide a description of the web site. In some instances, tag creation module 302a can ascertain a web site's tags and then present a user interface that can allow the user to select one or more of the tags that describe that web site. Once selected, the tags can be stored in store 308. Over time, store 308 can come to include a large number of tags that the user has created along with other relevant metadata.

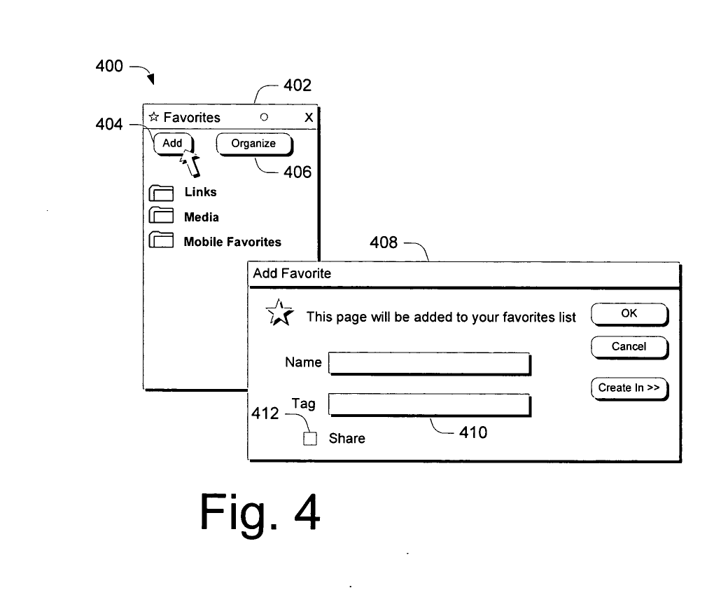

As but one example of how a user can create a tag using browser 302, consider the following in connection with FIG. 4. There, a portion of a browser user interface which can be provided by tag creation module 302a (FIG. 3) is shown generally at 400. In this example, interface portion 400 comprises a “Favorites Center” 402 that enables a user to manage their favorite web sites. As such, instrumentalities 404, 406 are provided and enable a user to add and organize their favorites, respectively. In this example, a user has selected the “Add” option by positioning their cursor over and clicking on the “Add” option. A tag can be created when a favorite is added, or later by accessing “properties” of the favorite within the “Favorites Center” . In this example, in response to clicking the “Add” option, an “Add Favorite” dialog 408 is presented and enables the user to add a web site or its link to their favorites list. In addition, notice a “Tag” input box 410. The “Tag” input box enables a user to enter a tag that is associated with the web site that they have added to their favorites list. Once added, the tag is stored in a tag list, such as the tag list stored in store 308 (FIG. 3). In addition, a tag-sharing module, such as module 302b (FIG. 3) can present a check box 412 for enabling a user to designate tags that are to be shared. If this box is checked, the associated tag in the tag list can include metadata that indicates that it is to be shared. It is to be appreciated and understood that the above-described tag functionality can be accessed through other means. For example, a user can access the tag functionality using the “Organize” option 406. Accordingly, by using the “Organize” option 406, a user can manage their tags by, for example, un-sharing shared tags or sharing tags that were previously not shared.

Continuing with reference to FIG. 3, API 303 can be used to expose the user's tags. Specifically, the application program interface or API can expose a callable method, such as GetTags( ), which can be called by other entities to ascertain which tags a user has chosen to expose. Hence, by-calling the appropriate API, an entity such as one or more of web sites 304 can learn which tags a particular user has chosen to share. By knowing which tags a user has chosen to share, a number of services can be provided for the user. Alternately or additionally, the API can be configured, through its arguments, to allow a caller to ask for tags sorted in any particular manner, e.g. by the number of occurrences (i.e. most frequently used), by a ranked list of favorite tags, by a user-specified number of tags, by a specified number of tags (i.e. no more than 5), and the like.

For example, some web sites might use the user's tags to specifically construct a front page with content that is tailored to the user's interests as a function of their tags. For example, a news site might construct a front page that includes new articles that have content that is associated with one or more of a user's tags. Alternately or additionally, other web sites, such as auction sites and commercial purchasing sites, might present content for bidding or purchase that is tailored to a particular user as a function of their tags. Alternately or additionally, a site may select advertisements that are tailored to a particular user based upon their tags. Accordingly, any number of services and/or information may be offered to a user based upon the tags that they have chosen to share.

Example Method

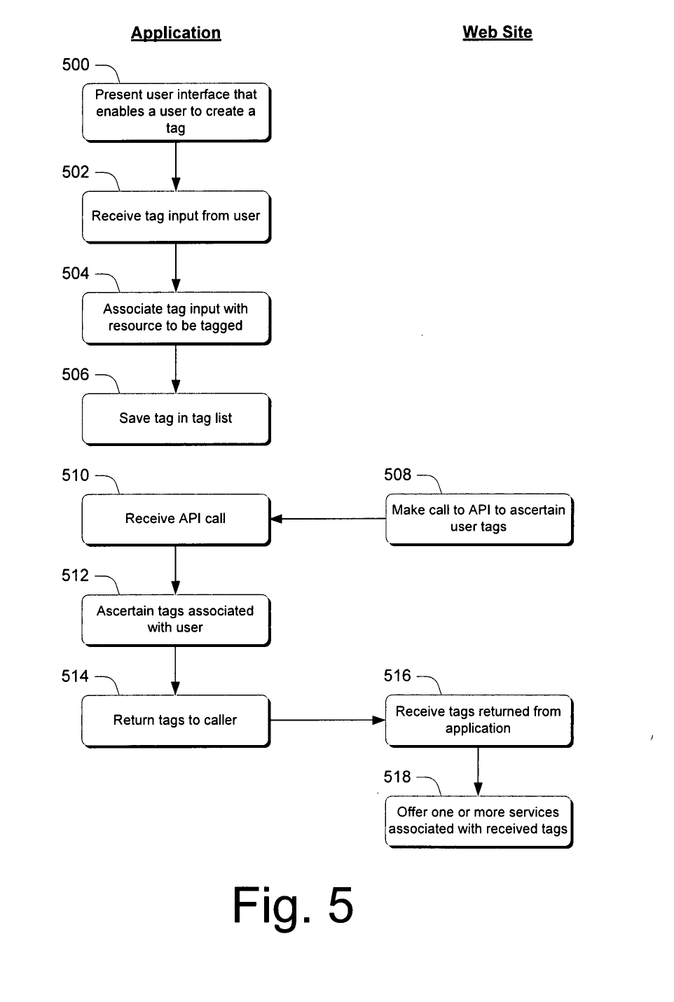

FIG. 5 is a flow diagram that describes steps in a method in accordance with one or more embodiments. The method can be implemented in connection with any suitable hardware, software, firmware or combination thereof. In at least some embodiments, aspects of the method can be implemented by an application, such as a suitably configured web browser. Yet other aspects of the method can be implemented by an entity, such as a web site. This is illustrated in the flow diagram by including portions of the method under the heading “Application”, and yet other portions under the heading “Web Site”.

Step 500 presents a user interface that enables a user to create a tag for a particular resource. Here, a resource can include, by way of example and not limitation, a web site and/or individual content that is accessible via a web site. Any suitable user interface can be used. In at least some embodiments in which the application comprises a web browser, the user interface can comprise part of the web browser's user interface. Other user interfaces can be utilized without departing from the spirit and scope of the claimed subject matter. Step 502 receives a tag input from the user and step 504 associates the tag that was input with a resource to be tagged. Examples of how this can be done are provided above. Step 506 saves the tag in a tag list. In at least some embodiments, the tag list is saved locally on the user's computing device. At this point, the application, such as a web browser, has created a tag, associated the tag with a resource such as a web page, and saved the tag in a tag list.

Step 508 makes a call to an API to ascertain one or more user tags. In one or more embodiments, the API is exposed by the application. The API call can include, as part of the parameters that are passed in the call, a specification of the maximum number of tags to be sent, a specification to send the most popular tags, a specification to send the most recent tags, or a specification that defines which tags should be sent using any suitable criteria.

Step 510 receives the API call and step 512 ascertains one or more tags associated with the user and, in at least some embodiments, that conform to the parameters that were passed in with the API call. Step 514 returns the tags to the caller.

Step 516 receives the tags that are returned from the application and step 51 8 offers one or more services associated with the received tags. Examples of services are provided above.

In the above example, a special API was provided to enable a web site to call into an application, such as a browser, to receive one or more tags that a user has chosen to share. In one or more embodiments, tags can be shared amongst web sites, services and/or applications without using a special API or API call.

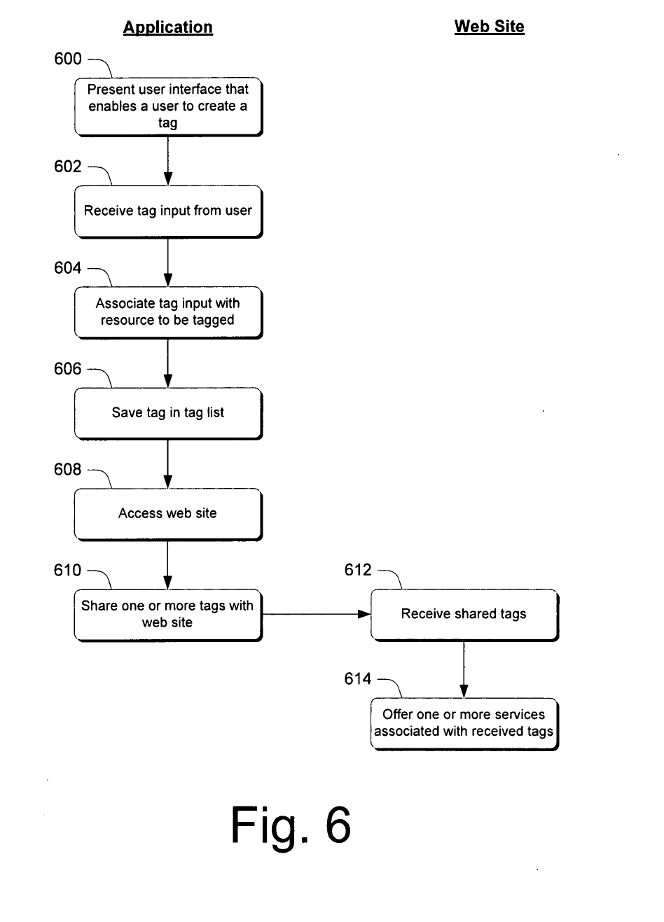

As an example, consider FIG. 6 which is a flow diagram that describes steps in a method in accordance with one or more embodiments. The method can be implemented in connection with any suitable hardware, software, firmware or combination thereof. In at least some embodiments, aspects of the method can be implemented by an application, such as a suitably configured web browser. Yet other aspects of the method can be implemented by an entity, such as a web site. This is illustrated in the flow diagram by including portions of the method under the heading “Application”, and yet other portions under the heading “Web Site”.

Step 600 presents a user interface that enables a user to create a tag for a particular resource. Here, a resource can include, by way of example and not limitation, a web site and/or individual content that is accessible via a web site. Any suitable user interface can be used. In at least some embodiments in which the application comprises a web browser, the user interface can comprise part of the web browser's user interface. Other user interfaces can be utilized without departing from the spirit and scope of the claimed subject matter. Step 602 receives a tag input from the user and step 604 associates the tag that was input with a resource to be tagged. Examples of how this can be done are provided above. Step 606 saves the tag in a tag list. In at least some embodiments, the tag list is saved locally on the user's computing device. At this point, the application, such as a web browser, has created a tag, associated the tag with a resource such as a web page, and saved the tag in a tag list.

Step 608 accesses a web site. This step can be performed in any suitable way as by, for example, accessing and loading a web page associated with the web site. Step 610 shares one or more tags with the web site. This step can be performed in any suitable way. For example, a suitably configured tag sharing module, such as tag sharing module 302b (FIG. 3) may, in the communication that takes place between a user's application (such as a web browser) and the web site, include tags that a user has chosen to share. For example, such tags can be included in one or more packets that are transmitted to the web site as by being located in a header or some other part of the packet. It is to be appreciated and understood that any suitable communication technique or protocol can be used to share the tags.

Step 612 receives the tags that are share by the application and step 618 offers one or more services associated with the received tags. Examples of services are provided above.

Having described how tags can be created and shared, consider now an example system that can be utilized to implement one or more of the above-described embodiments.

Example System

FIG. 7 illustrates an example computing device 700 that can implement the various embodiments described above. Computing device 700 can be, for example, computing device 102 of FIG. 1 or any other suitable computing device.

Computing device 700 includes one or more processors or processing units 702, one or more memory and/or storage components 704, one or more input/output (I/O) devices 706, and a bus 708 that allows the various components and devices to communicate with one another. Bus 708 represents one or more of any of several types of bus structures, including a memory bus or memory controller, a peripheral bus, an accelerated graphics port, and a processor or local bus using any of a variety of bus architectures. Bus 708 can include wired and/or wireless buses.

Memory/storage component 704 represents one or more computer storage media. Component 704 can include volatile media (such as random access memory (RAM)) and/or nonvolatile media (such as read only memory (ROM), Flash memory, optical disks, magnetic disks, and so forth). Component 704 can include fixed media (e.g., RAM, ROM, a fixed hard drive, etc.) as well as removable media (e.g., a Flash memory drive, a removable hard drive, an optical disk, and so forth).

One or more input/output devices 706 allow a user to enter commands and information to computing device 700, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments provide a mechanism by which a user's tags can be shared across a variety of web sites, applications or services, in addition to those web sites where a particular tag may have been created. In one or more embodiments, an application program interface (API) is provided and exposes one or more methods by which a user's tags can be exposed. Once a user's tags are exposed and discoverable, various services and information can be provided which are tailored to a particular individual as a function of their tags.

In one or more embodiments, an API is supported by a web browser and provides a means by which other entities, such as web sites, can ascertain tags associated with a particular individual. Once the tags are discovered, these other web sites can offer a host of services that are specifically tailored to the individual as a function of the individual's tags.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
one or more computer-readable media;
a web browser embodied on the one or more computer-readable media, the web browser comprising:
a tag creation module to enable a user to create one or more tags; and
a tag sharing module to enable a user to share said one or more tags with multiple different web sites, wherein the tag sharing module is configured to enable said multiple different web sites to ascertain individual tags associated with an individual user.

2. The system of claim 1, wherein the tag sharing module is configured to enable a user to choose to share a tag.

3. The system of claim 1, wherein the tag sharing module is configured to receive calls from multiple different web sites and, responsively, share tags that a user has chosen to share with web sites from which said calls are received.

4. The system of claim 1, wherein the web browser is configured to enable the user to create and share a tag when the user adds a link via the web browser.

5. The system of claim 1, wherein the web browser is configured to enable a user to share a tag from a favorites center.

6. The system of claim 1, wherein the web browser is configured to save tags in a local tag list, along with metadata associated with individual tags.

7. The system of claim 6, wherein the metadata includes an indication of whether a user has chosen to share a particular tag.

8. The system of claim 1, wherein the tag sharing module is configured to automatically share tags without requiring a special API call.

9. A computing device embodying the system of claim 1.

10. One or more computer-readable storage media embodying an application program interface that is configured to:
receive calls that request tags that a user has chosen to share, wherein the calls are received from entities other than those that enabled the user to create a tag; and
share those tags that a user has chosen to share with said entities.

11. The one or more computer-readable media of claim 10, wherein the application program interface is supported by a web browser.

12. The one or more computer-readable media of claim 10, wherein the application program interface is configured to receive calls from multiple different web sites.

13. The one or more computer-readable media of claim 10, wherein at least some of the calls can specify a number of tags to be returned.

14. The one or more computer-readable media of claim 10, wherein the application program interface is configured to share a tag with one or more web sites other than one where a particular tag was created.

15. A computing device embodying the one or more computer-readable media of claim 10.

16. A computer-implemented method comprising:
making a call to an application program interface to ascertain one or more tags that a user has chosen to share;
receiving one or more tags responsive to making said call; and
offering one or more services associated with the one or more tags that are received.

17. The method of claim 16, wherein said call can specify a number of tags to return.

18. The method of claim 16, wherein said call can specify criteria to use that defines which tags should be returned.

19. The method of claim 16, wherein the act of making a call is performed by making a call to an application program interface supported by a web browser.

20. The method of claim 16, wherein the act of offering is performed by tailoring content as a function of the one or more tags that are received.
